(19) United States
(12) Patent Application Publication
(10) Pub. No.: US 2015/0088360 A1
(43) Pub. Date: Mar. 26, 2015

(54) Method for Autonomous Parking of a Motor Vehicle, Driver Assistance Device for Performing the Method and Motor Vehicle with the Driver Assistance Device

(71) Applicant: Daimler AG, Stuttgart (DE)

(72) Inventors: Christophe Bonnet, Leinfelden-Echterdingen (DE); Andreas Hiller, Stuttgart (DE); Gerhard Kuenzel, Benningen (DE); Martin Moser, Fellbach (DE); Heiko Schiemenz, Stuttgart (DE)

(73) Assignee: Daimler AG, Stuttgart (DE)

(21) Appl. No.: 14/397,282

(22) PCT Filed: Jan. 29, 2013
(86) PCT No.: PCT/EP2013/000259

§ 371 Date: Oct. 27, 2014

(30) Foreign Application Priority Data
Apr. 28, 2012 (DE) 10 2012 008 858.2

(51) Int. Cl. B60W 30/06

(52) U.S. Cl. CPC B60W 30/06
USPC 701/23

(57) ABSTRACT

An autonomous parking procedure of a motor vehicle involves transferring a command to activate the autonomous parking procedure using a communication link between an operator situated outside the motor vehicle and the motor vehicle. Before beginning the autonomous parking procedure of the motor vehicle the target position and/or last driven trajectory of the motor vehicle is stored in a storage device. The motor vehicle then performs the parking procedure autonomously from the start position using the stored data after the first activation of the autonomous parking procedure.

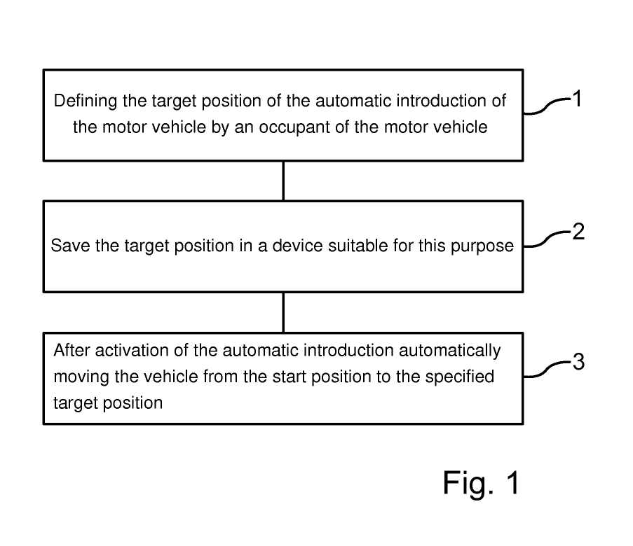

### BACKGROUND AND SUMMARY OF THE INVENTION

Exemplary embodiments of the invention relate to a method for autonomous parking of a motor vehicle, a driver assistance device for performing the method and a motor vehicle having the driver assistance device. Expressed generally, exemplary embodiments of the present invention are directed to an automatic parking system, preferably with external radio control, in which the target position and/or last driven trajectory of the motor vehicle is determined before the beginning the autonomous parking procedure of the motor vehicle and is stored in a device that is suitable for this.

The width of motor vehicles, in particular of passenger vehicles, has continuously increased in the last few years or decades. The width of parking spaces for motor vehicles, however, has not been adapted to this development. From this results the problem that, for a parked vehicle, the doors thereof can often only be opened at a comparably small angle, which makes leaving the motor vehicle more difficult for the passengers.

In this context, in the last few years, automatic and autonomous solutions have been developed, in which the passengers can exit before the parking space and then the parking of the motor vehicle is initiated via radio. Among these solutions there are solutions in which the motor vehicle can only move straight forwards and backwards, but also those in which the motor vehicle detects the parking space and the surroundings of the motor vehicle using suitable sensor devices and can park automatically by calculating and controlling the trajectory into a parking space.

Thus, for example, German patent document DE 101 20 511 B4 describes a parking aid device having target steering amount equipment to find a steering amount necessary to position a vehicle in a parking space or to find a target steering amount representing a steering position, an automatic steering means for the operation of a real steering amount of the vehicle or a real steering amount, which represents a steering position, in order to coincide with the target steering amount; a remote control device to command the backward movement and stopping of the vehicle and an operation control device for the backward movement and stopping of the vehicle corresponding to the command from the remote control device.

European patent document EP 1 249 379 A2 discloses a method for driving a motor vehicle into a target position in which the motor vehicle is brought into a start position close to the intended target position, continuously scans the surroundings of the motor vehicle after a first driver-side activation and at least for the detection of the target position, and the current driving position is continuously determined, control information for the driving of the motor vehicle into the target position is determined by means of the determined surroundings and positional information; after a second driver-side activation, control commands that are dependent on the control information are transmitted to the drive train and/or the braking system and/or the steering of the motor vehicle, whereby the motor vehicle drives into the target position independently of the driver.

Furthermore, German patent document DE 10 2009 041 587 A1 describes a driver assistance device with a control device designed to emit control signals to a drive and steering device of the motor vehicle, the signals implementing an autonomous parking procedure. The control device is also designed to receive commands from a remote control and to interrupt a parking procedure of the motor vehicle that has already begun after receiving a pre-determined interruption command. At least one camera is coupled to the control device and obtains image data concerning a surrounding region of the motor vehicle. The control device sends signals to the remote control, which comprise image data obtained by the camera or image data calculated therefrom.

Videos and some written information about the functionality of prototypes of autonomous systems are able to be viewed on the internet at ww.youtube.com/watch?v=hIL_pl7jxGQ and www.youtube.com/watch?v=KfUBTOTp2Fw (Remote Park Assist, BMW); https://www.volkswagen-mediaservices.com/medias_publish/ms/content/de/pressemitteilungen/2008/04/21/weltpremie re_auf_der.standard.gid-oeffentlichkeit.html, http://heise.de/-449087, http://www.youtube.com/watch?v=A6eflkzkr5l (Park Assist Vision, VW); http://www.valeo.com/de/pressemitteilungen/details.html?id=195, http://www.youtube.com/watch?v=aeRUkNRyycA (Park4U® Remote, Valeo).

Several technical developments that have been made in the past few years in series production support the introduction of corresponding systems. Thus, an electrical steering support of automatic steering, an electronic control of accelerator and brake, the electrical parking brake, as well as electrical control of the gear shift enable the autonomous regulation of the longitudinal movement.

Parallel to this, radio remote controls are more and more prevalent in the movement of machines and vehicles in semi-public space, e.g. in cranes, other construction machines or shunting locomotives. Also, in the automobile industry, radio systems with corresponding security technology for opening and closing are widely distributed. Solutions are also already known in which a control of non-vehicle functions such as opening, closing, flashing or sounding of the horn is enabled with the aid of smartphones (My BMW Remote App. Flyer: “BMW CONNECTED DRIVE.” page 9, 2011).

The autonomous parking systems having remote control presented as prototypes base their control concept on existing automatic parking systems. In other words, the vehicle recognizes the parking space with its environment sensors, plans a trajectory and drives at this trajectory based on the requirement of the operator.

Here, however, parking spaces that can be driven into are limited to those in situations considered in the system. Thus, for example, tight parking situations in private parking spaces can thus partially not be supported, as the system cannot determine the desired end position.

Accordingly, exemplary embodiments of the present invention are directed to an improved solution to overcome these disadvantages of the prior art.

In the autonomous parking method for a motor vehicle in exemplary embodiments of the present invention there is a communication link between an operator situated outside the motor vehicle and the motor vehicle, the communication link can transfer at least one command to activate the autonomous parking procedure of the motor vehicle. Before the beginning of the autonomous parking procedure of the motor vehicle, the target position and/or last driven trajectory of the motor vehicle is stored in a storage device. After the first activation of the autonomous parking procedure, the motor vehicle performs the parking procedure autonomously from the start position by means of data stored in the device.

The determination of the target position of the autonomous parking procedure can occur in the following manner. The motor vehicle is first brought into the target position by a driver before the beginning of the autonomous parking procedure. Here, the target position and/or the trajectory to the target position are stored in a device. Alternatively, the target position is detected by a suitable sensor device of the motor vehicle in surroundings of the motor vehicle encompassing the target position. This is signaled to a passenger of the motor vehicle and the passenger of the motor vehicle then determines the target position of the motor vehicle within the detected surroundings and the trajectory to the target position and this is stored in a device. Alternatively, the position of the last change of direction of the motor vehicle is detected, i.e. the position of the motor vehicle before being changed from forward travel to backward travel or vice versa, and this position is stored as a target position in a device.

By determining the target position before beginning the autonomous driving of the motor vehicle by, for example, a passenger of the motor vehicle, the motor vehicle can move autonomously into the target position independent of any parameters with respect to the target position which would have to be entered into the system in advance.

According to a first advantageous development of the invention, the determining of the target position of the autonomous driving occurs in that the motor vehicle is driven by a driver into the target position and the target position is stored in the device, or surroundings of the motor vehicle comprising the target position are detected by a suitable sensor device of the motor vehicle, this is signaled to a passenger of the motor vehicle and the target position of the motor vehicle within the detected surroundings and the trajectory with respect to the target position are determined by the passenger of the motor vehicle and are stored in the device.

According to a further advantageous development of the invention, the start position of the motor vehicle, the trajectory into the target position as well as data concerning the surroundings of the motor vehicle during the autonomous driving of the motor vehicle into the target position are detected and stored in the device. Hereby it can advantageously be achieved that the motor vehicle moves autonomously again into the start position or substantially in a straight line forwards or backwards after a second activation of the autonomous driving. In the case of this driving/movement, it can be advantageously be checked by at least one suitable sensor device on the vehicle side as to whether the surroundings of the motor vehicle have changed since the driving of the motor vehicle into the target position, and whether the motor vehicle autonomously prevents or stops its movement before or during the autonomous driving in the case of a change of the surroundings and signals the change.

According to yet another advantageous development of the invention, a wireless communication link exists between an operator situated outside the motor vehicle and the motor vehicle, using which at least one command for the activation of the autonomous driving of the motor vehicle or another control command to the motor vehicle and/or information on the vehicle side is able to be transferred to the operator. Hereby, advantageously, the activation of the autonomous driving of the motor vehicle into the target position, the activation of the backward movement of the motor vehicle into the start position and/or the activation of the substantially straight-line movement forwards or backwards of the motor vehicle by the operator can occur outside of the vehicle with the aid of a wireless connection device. Furthermore, advantageously, the movement of the motor vehicle can be stopped during the autonomous driving as soon as the operator sets definable operational actions in the communication device.

Furthermore, the motor vehicle can drive back into the stored start position again during the autonomous parking procedure as soon as the operator sets a predetermined operational action in the communication device.

The present invention also comprises a driver assistance device, which can be connected to control and sensor devices of a motor vehicle. The driver assistance device is equipped to perform one of the methods according to the invention. Furthermore, the present invention comprises a motor vehicle having such a driver assistance device.

### BRIEF DESCRIPTION OF THE DRAWINGS

The present invention is illustrated in more detail by means of the enclosed drawing.

The FIGURE shows, purely schematically, the steps of one of the preferred embodiments of the method according to the invention.

### DETAILED DESCRIPTION

The exemplary embodiments that are depicted in more detail below present preferred embodiments of the present invention. The present invention is naturally not limited to these embodiments.

As is already mentioned above, a preferred embodiment of the present invention relates, among other things, to a method for autonomous parking of a motor vehicle from a start position into a target position, wherein the motor vehicle moves autonomously from the start position to the target position after an activation of the autonomous driving. In the preferred embodiment of the method according to the invention before the beginning of the autonomous parking of the motor vehicle into the target position, the target position of the autonomous driving is determined 1 by a passenger of the motor vehicle and is stored 2 in a device that is suitable for this and the motor vehicle moves 3 autonomously from the start position into the determined target position after a first activation of the autonomous driving.

The determination of the target position by a passenger of the motor vehicle 1 can occur advantageously, for example, in that the driver first drives into the target position (park position) and enters (temporarily or permanently stores) this target position in the system (in a suitable device). Then the driver can move the motor vehicle away from the target position (park position) again, for example to a position close to the target position (park position), which enables the passengers to exit the motor vehicle comfortably. An operator can then, for example, activate the autonomous parking procedure from the outside (e.g. by means of a remote control device) and the motor vehicle drives independently back again along the path towards the entered park position.

Using this type of determination of the target position of the motor vehicle 1, the driver or another passenger accepts the responsibility that there are no undesirable obstacles present on the path to the target position and at the target position. Thus, the requirements for the sensors are lower than is the case in completely autonomous systems.

Another advantageous possibility for the determination of the target position by a passenger (driver/front-seat passenger) of the motor vehicle 1 is that the motor vehicle is switched off in a position close to the target position, surroundings of the motor vehicle comprising the target position are detected by a suitable sensor device of the motor vehicle, this target position is signaled to a passenger of the motor vehicle, and the target position of the motor vehicle within the detected surroundings and the trajectory to the target position is determined by the passenger of the motor vehicle and is entered (temporarily or permanently stored) in the system (suitable device).

For the detection of the target position, for both of the alternatives mentioned above, different sensor systems of the motor vehicle are used, for example at least one camera device (surround-view cameras, rear-view camera), ultrasound sensor device (park distance control), radar device, laser scanning device (as long as a sufficient level of accuracy of the position determination is provided), a satellite-supported position determination, etc. These sensor systems can naturally be used in combination and the pieces of data from different sensor systems can be referenced to one another and/or synchronized with one another.

For example, the position close to the target position can be one that enables a comfortable exit. The sensor device can, for example, comprise at least one camera device and the image detected by the camera device (which comprises the target position) is displayed to a passenger on a screen (as a real image or a processed image). The passenger can now select and confirm the final target position (park position) and the trajectory thereto in the camera image, for example with inserted graphical elements. This applies both for a target position (park position) in front of the car (camera device, for example having surround-view cameras), and for a position behind the motor vehicle (camera device, for example having a rear-view camera). For the selection and confirmation of the target position (park position) and the trajectory, either suitable buttons (e.g. stationary, forwards, backwards, park, unpark, steer, confirmation of obstacle) in the vehicle, and/or the steering angle, are used.

Advantageously, the start position of the motor vehicle, the trajectory to the target position as well as data concerning the surroundings of the motor vehicle are detected during the autonomous driving of the motor vehicle into the target position and are stored in the device.

The data concerning the surroundings of the motor vehicle can also comprise “soft” obstacles such as, for example, a bush. According to the invention, the passenger of the vehicle who determines the target position and/or the trajectory to the target position can accept or even knowingly select contact of the motor vehicle with such a “soft” obstacle during autonomous movement of the motor vehicle from the start position to the target position (parking) or during autonomous movement of the motor vehicle from the target position to the start position (unparking). Such soft obstacles cannot currently be correctly evaluated by the environmental sensors of a completely automatic system.

If the data regarding the start position of the motor vehicle, the trajectory into the target position as well as the data concerning the surroundings of the motor vehicle is stored during the autonomous driving of the motor vehicle into the target position, this data is still available for an autonomous leaving of the target position (unparking) Therefore, in such a case, the motor vehicle can move autonomously back into the start position or substantially in a straight line forwards or backwards after a second activation of the autonomous driving.

In the case of an autonomous leaving of the target position (unparking), it is advantageously checked by at least one suitable sensor device on the vehicle side as to whether the surroundings of the motor vehicle have changed since the driving of the motor vehicle into the target position. If this is the case, the motor vehicle can advantageously autonomously prevent or stop its movement before or during the autonomous driving and signal the change.

A signaling of a change of the surroundings of the motor vehicle since the autonomous driving into the target position, for example a newly parked vehicle in the surroundings of the motor vehicle, can, for example, occur by an actuation of the horn and/or by an actuation of the hazard lights. Also, such a signaling can occur by a transfer and signaling of corresponding data from the motor vehicle to a remote control device controlled by the operator.

The method according to the invention serves, in particular, for the autonomous parking and unparking of a motor vehicle in tight spaces. These tight spaces can relate only to one longitudinal side of the motor vehicle (e.g. parking space along a wall) or also to both longitudinal sides of the motor vehicle (head parking space). In order to enable, in all cases, all passengers to exit the motor vehicle before the beginning of the autonomous driving of the motor vehicle to the target position, it must be possible for all passengers of the motor vehicle to be able to leave this before the motor vehicle is set into motion for the procedure of the autonomous driving to the target position. Similarly, it must be possible for the motor vehicle to be able to move away from the target position to the start position or in a substantially straight-line movement away from the target position autonomously, without a passenger having to get back into the motor vehicle beforehand.

This can be particularly advantageously achieved if a wireless communication link exists between an operator situated outside the motor vehicle and the motor vehicle, by means of which at least one command for the activation of the autonomous driving of the motor vehicle or another control command to the motor vehicle and/or information on the vehicle side is able to be transferred to the operator. Hereby, the activation of the autonomous driving of the motor vehicle into the target position, the activation of the backward movement of the motor vehicle into the start position and/or the activation of the substantially straight-line movement forwards or backwards of the motor vehicle by the operator can occur outside the vehicle with the aid of a wireless communication device.

For unparking, an operator can, for example, start the autonomous driving from the target position to the start position by radio from the outside. After that, the motor vehicle moves autonomously to the stored start position, which enables a comfortable entry into the motor vehicle.

Starting the autonomous driving (movement to and movement from the target position) can, for example, take place by pressing a button or a button combination on the communication device. Likewise, stopping the procedure of the autonomous driving can take place by pressing a button or a button combination on the communication device.

To increase safety, it can furthermore be provided that the movement of the motor vehicle during the autonomous driving (movement to and movement from the target position) is stopped as soon as the operator sets a predetermined operational action in the communication device. For example, it can be provided that the operator must keep a button or a button combination on the communication device pressed down during the entire procedure of the autonomous driving. As soon as the button or the button combination is no longer pressed, the motor vehicle stops its movement. Also, for example, it can be provided that, during the autonomous driving of the motor vehicle, the operator must continuously, or at least at comparably short intervals, perform a determined movement on the screen (for example swiping or circling) on a communication device having a touch-sensitive screen (touch display), so that the autonomous driving is not stopped (in the sense of a “dead man's control”).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method, comprising:
transferring, over a communication link between an operator situated outside a motor vehicle and the motor vehicle, at least one command to activate an autonomous parking procedure of the motor vehicle;
storing a target position and/or last driven trajectory of the motor vehicle in a storage device before beginning the autonomous parking procedure; and
autonomously parking the motor vehicle from a start position using the stored target position and/or last driven trajectory after activation of the autonomous parking procedure.

12. The method of claim 11, wherein the target position of the autonomous parking procedure is determined by one of:
a) driving, by a driver, the motor vehicle into the target position; and
storing the target position and/or the trajectory to the target position;
b) detecting surroundings of the motor vehicle comprising the target position using sensor of the motor vehicle;
signalling the detected surroundings to a passenger of the motor vehicle;
determining, by the passenger of the motor vehicle, the target position of the motor vehicle within the detected surroundings and the trajectory to the target position; and
storing the determined target position of the motor vehicle within the detected surroundings and the trajectory to the target position; or
c) detecting a position of a last change in direction of the motor vehicle; and
storing the detected position of the last change in direction of the motor vehicle.

13. The method of claim 11, wherein the start position of the motor vehicle, the trajectory to the target position and the surroundings of the motor vehicle are detected during the autonomous parking procedure and are stored in the storage device.

14. The method of claim 13, wherein after a second activation of the autonomous parking procedure, the motor vehicle moves autonomously
back into the start position, or
in a straight-line forwards or backwards.

15. The method of claim 14, further comprising:
checking, by at least one sensor on the motor vehicle, as to whether the surroundings of the motor vehicle have changed since the parking procedure of the motor vehicle into the target position;
autonomously preventing or stopping, by the motor vehicle, movement of the motor vehicle before or during the autonomous parking procedure when there is a change of the surroundings; and
generating a signal indicating the change of the surroundings.

16. The method of claim 14, wherein the activation of the autonomous parking procedure of the motor vehicle into the target position, the activation of the backwards movement of the motor vehicle into the start position, or the activation of the straight-line movement forwards or backwards of the motor vehicle by the operator occurs outside the motor vehicle using a wireless communication device.

17. The method of claim 16, wherein movement of the motor vehicle during the autonomous parking procedure is stopped as soon as the operator sets a predetermined operational action in the wireless communication device.

18. The method of claim 17, wherein the motor vehicle drives into the stored start position during the autonomous parking procedure as soon as the operator sets a predetermined operational action in the wireless communication device.

19. A driver assistance device, comprising:
a communication device configured to receive, over a communication link between an operator situated outside a motor vehicle and the motor vehicle, at least one command to activate an autonomous parking procedure of the motor vehicle;
a data storage device configured to store a target position and/or last driven trajectory of the motor vehicle in a storage device before beginning the autonomous parking procedure; and
an autonomous parking system configured to autonomously parking the motor vehicle from a start position using the stored target position and/or last driven trajectory after activation of the autonomous parking procedure.

20. A motor vehicle, comprising:
a driver assistance device, comprising
a communication device configured to receive, over a communication link between an operator situated outside a motor vehicle and the motor vehicle, at least one command to activate an autonomous parking procedure of the motor vehicle;
a data storage device configured to store a target position and/or last driven trajectory of the motor vehicle in a storage device before beginning the autonomous parking procedure; and
an autonomous parking system configured to autonomously parking the motor vehicle from a start position using the stored target position and/or last driven trajectory after activation of the autonomous parking procedure.
